(19) United States
(12) Patent Application Publication
(10) Pub. No.: US 2013/0250339 A1
(43) Pub. Date: Sep. 26, 2013

(54) METHOD AND APPARATUS FOR ANALYZING AND PROCESSING RECEIVED FAX DOCUMENTS TO REDUCE UNNECESSARY PRINTING

(71) Applicant: Wei MING, Cupertino, CA (US)

(72) Inventor: Wei MING, Cupertino, CA (US)

(73) Assignee: KONICA MINOLTA LABORATORY U.S.A., INC., San Mateo, CA (US)

(21) Appl. No.: 13/427,774

(22) Filed: Mar. 22, 2012

(51) Int. Cl. G06K 15/02

(52) U.S. Cl. 358/1.14

(57) ABSTRACT

A method implemented in a fax machine for analyzing and processing received fax documents to identify unwanted faxes. The method applies a content based analysis to textual contents extracted from the fax by OCR, and applies an image pattern analysis to the image of the fax, as well as a statistical analysis based on past analysis results and user actions of faxes from the same sender. An overall relevance value is calculated based on the above analyses and is used to determine whether the received fax is unwanted. For unwanted faxes, the fax machine either prints the fax using a low quality printing mode, or save the fax in a memory without printing it. The user may subsequently perform various actions on the fax document, such as printing, reprinting, forwarding, deleting, etc. Such user actions are recorded as a part of the statistical information used in the statistical analysis.

### BACKGROUND OF THE INVENTION

1. Field of the Invention

This invention relates to fax machines, and in particular, to a method implemented in fax machines for analyzing and processing received fax documents to reduce unnecessary printing of faxes.

2. Description of Related Art

Fax is often used to send unsolicited commercial information such as advertisement or other unwanted information sometimes referred to as “junk”. Conventional fax machines prints all received fax documents without discrimination. As a result, many unwanted faxes are printed, resulting in waste of paper, ink and toner. Sometimes, even if the unsolicited information is found useful by the recipient, it is often the case that such faxes do not need to be printed in a high quality printing mode.

### SUMMARY

The present invention is directed to a method and related apparatus for analyzing and processing received fax documents with the objective of reducing unnecessary or unwanted printing of fax documents, thereby saving resources such as paper, ink and toner.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a fax machine for analyzing and processing a received fax document, the fax document being in the form of an image, including: (a) performing optical character recognition on the image to extract textual content of the received fax document; (b) analyzing the textural content to obtain a first plurality of factor values; (c) analyzing patterns of the image to obtain a second plurality of factor values; (d) performing statistical analysis based on stored statistical data and a detected identification of a sender of the fax document to obtain a third plurality of factor values; (e) determining whether the received fax document is unwanted or legitimate based on the first, second and third plurality of factor values; and (f) when the received fax document is determined to be legitimate, printing the fax document, and when the received fax document is determined to be unwanted, either printing the fax document using a lower image quality or saving the fax document in the fax machine without printing it.

Step (b) may include: obtaining, as the first plurality of factor values, frequencies of occurrences of one or more or more of: a description of goods or service provided, contact information, price information, sale information, valid period of goods or services offered, and goods or services quality information.

Step (c) may include: obtaining, as the second plurality of factor values, one or more or more of: an average character size of the fax document, a standard deviation of character size of the fax document, a ratio of character size at a first percentile value over character size at a second percentile value of the fax document, a difference between average of density of text areas of the fax document and a predefined density value, and a standard deviation of density of text areas of the fax document.

Step (d) may include: obtaining from stored statistical data, as the third plurality of factor values, a number of fax documents from the sender that has been previously determined to be unwanted by the fax machine, a number of fax documents from the sender that has been previously determined to be unwanted by a user, a numbers of fax documents from the sender that has been previously determined to be legitimate by the fax machine, and a numbers of fax documents from the sender that has been previously determined to be legitimate by the user.

The method may further include, after steps (a) through (d) and before step (e), (g) calculating an overall relevance value using the first, second and third plurality of factor values and a plurality weighting factors, each weighting factor being associated with one factor value of the first, second and third plurality of factor values; and wherein step (e) comprises determining whether the received fax document is unwanted or legitimate by comparing the overall relevance value with a threshold value.

Step (a) may further include calculating a first relevance value using the first plurality of factor values and a first plurality weighting factors, each of the first plurality of weighting factors being associated with one of the first plurality of factor values; step (b) may further include calculating a second relevance value using the second plurality of factor values and a second plurality weighting factors, each of the second plurality of weighting factor being associated with one of the second plurality of factor values; step (c) may further include calculating a third relevance value using the third plurality of factor values and a third plurality weighting factors, each of the third plurality of weighting factor being associated with one of the third plurality of factor values; and step (e) may include determining whether the received fax document is unwanted or legitimate by comparing the first, second and third relevance values with respective first, second and third threshold values.

In another aspect, the present invention provides a fax machine which includes: a scanning section for scanning hard copy documents to be sent as fax; a printing section for printing received fax documents; a communication interface section for transmitting and receiving fax documents; a user interface section for receiving user input; a memory for storing computer readable program code and data; and a processing section for executing the computer readable program code stored in the memory to control the fax machine to perform the above methods.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a method implemented in a fax machine for analyzing and processing received fax documents according to an embodiment of the present invention.

FIG. 2 schematically illustrates a fax machine in which a method according to embodiments of the present invention may be implemented.

### DETAILED DESCRIPTION OF PREFERRED EMBODIMENTS

While spam filters are widely used for emails, they are not readily available for fax machines. Embodiments of the present invention provide a method, implemented in a fax machine (including any machine that has the ability to receive and automatically print out fax documents, for example multi-function printer (MFP), all-in-one (AIO) printer, etc), for analyzing and processing receive fax documents to identify possible unwanted faxes, functioning as a spam filter for fax machines.

In this disclosure, the term “unwanted faxes” generally refers to faxes that are advertisement or otherwise commercial in nature, which are often sent without prior consent or invitation by the fax recipient. The fax machine can determine whether a received fax is likely to be unwanted fax. It should be noted that a fax determined by the fax machine to be unwanted may or may not actually be unwanted by the user.

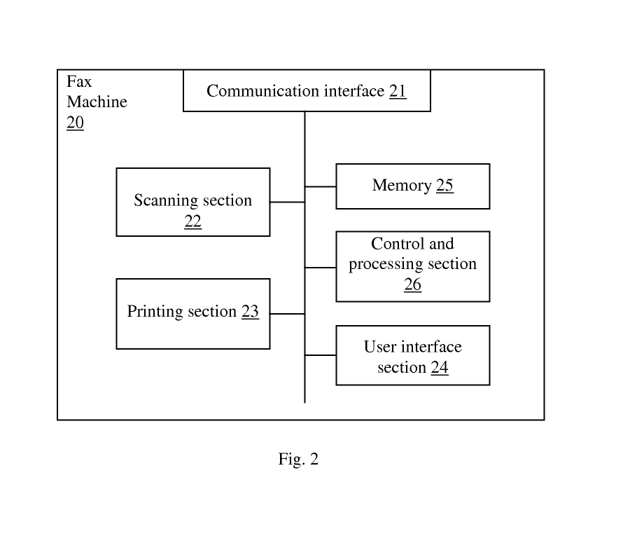

The method may be implemented by software or firmware code stored in a memory of the fax machine and executed by a processor of the fax machine. As shown in FIG. 2, the fax machine 20 according to embodiments of the present invention includes a communication interface section 21 for receiving and transmitting fax signals via a telephone line, a scanning section 22 for scanning hard copy documents to be sent as faxes, a printing section 23 for printing received faxes, a user interface section 24 (e.g., push buttons, a display panel, etc.) for interacting with users, a memory 25 for storing program code and other data, and a processing section 26 for controlling various components of the fax machine and performing various processing. These components are connected to each other via a suitable communication link such as a bus. The fax document analysis and processing method described below is implemented as program code stored in the memory and executed by the processing section.

The method for analyzing and processing received fax documents uses content based analysis and image pattern analysis to detect possible unwanted faxes. If a received fax document is determined to be possible unwanted fax, certain actions may be taken, such as: printing the received fax document in a toner saving printing mode to generate a lower quality printout; saving the fax document in the memory without printing it, while printing or displaying a notification to the user; etc. The analysis and processing method preferably has a self learning ability based on statistical analysis of past user actions (e.g., a user may confirm or reverse the determination made by the fax machine) to improve the accuracy of the determination.

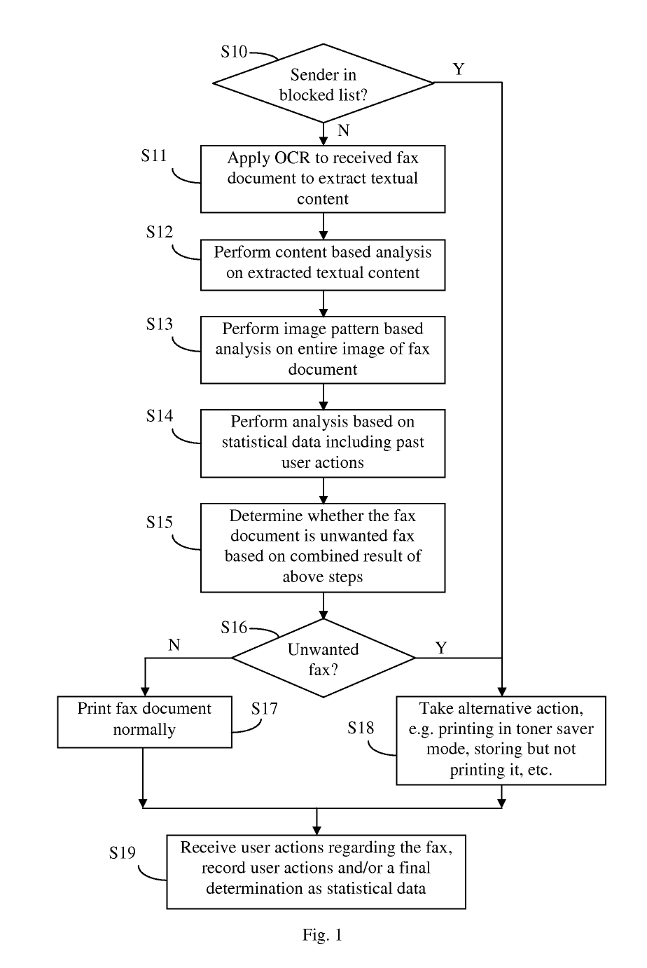

FIG. 1 illustrates a method of analyzing and processing received fax documents according to an embodiment of the present invention. As a received fax document is in the form of a bitmap image, an OCR (optical character recognition) step is applied to extract the textual content contained in the fax document (step S11). Then, the extracted textual content is analyzed (step S12), as will be described in more detail later. An image pattern based analysis is applied to the entire image of the fax document (step S13), as will be described in more detail later. A further statistical analysis based on statistical data, including past user actions, is applied to the fax document (step S14), as will be described in more detail later. Then, the result of the analyses in steps S12, S13 and S14 are combined to determine whether the received fax document is unwanted fax (step S15).

It should be noted that since steps S13 and S14 do not depend on the text extracted by the OCR step S11, they can be performed before step S11. Generally, the order of steps S11 to S14 is not important so long as step S11 is performed before step S12.

If the fax is determined to be legitimate (i.e. not unwanted) fax (“N” in step S16), it is printed out normally (step S17). If the fax is determined to be an unwanted fax (“Y” in step S16), an alternative action is taken (step S18). For example, the fax may be printed in a toner saving mode (lower printing quality), or it may be saved in the memory of the fax machine but not printed out. If the fax is not printed, an appropriate alert may be generated to alert the user of the existence of a received but unprinted fax. The alert may be a flashing light, a message displayed on the display panel of the fax machine, a beep, a message sent to a separate information receiver of the user via email, instant messaging, text messaging, etc. In addition, if the fax is determined to be unwanted (“Y” in step S16), it is moved to a “junk” folder and the image is saved in the memory of the fax machine. Such saved faxes are available to be printed by the user later.

Subsequently, the user may act upon the received fax or the alert. For example, when the fax machine determines that a fax is unwanted, and the user confirms such determination, the user may delete the fax, move it to a “confirmed junk” folder, or take no action (i.e., not printing the fax, not moving it out of the junk folder, etc.). Or, if the user determines that the fax is in fact legitimate, the user may move it out of the junk folder, print or reprint the fax, or forward it, etc. On the other hand, when the fax machine determines that a fax is legitimate (and therefore prints it normally in step S17), and the user confirm such determination, the user may take no further action, or he may reprint the fax or forward it, etc. Or, if the user determines that the fax is in fact unwanted, the user may delete it or move it to the junk folder or the “confirmed junk” folder. The fax machine receives such user actions (including printing, reprinting, forwarding, deleting, moving to junk or confirmed junk folder, moving out of junk folder, taking no action, etc.), and records them as a part of the statistical information in association with the fax sender's identity (e.g. sender's fax number) (step S19). Alternatively, instead of or in addition to recording the user actions, the fax machine records, as a part of the statistical information, a confirmed determination of whether the fax is unwanted based on the user actions. Such statistical information may be used later in the statistical analysis of step S14 or a self-learning process.

In addition, a “blocked sender” list may be maintained based on user actions. For example, if the user affirmatively moves a fax into the junk folder or the confirmed junk folder, the sender's fax number may be added to the blocked sender list in step S19 (user confirmation is preferably required before adding a sender to the blocked sender list). Subsequently, if other faxes are received from the same sender, the fax machine may determine these faxes to be unwanted (“Y” in step S10) without performing the analysis in steps S11 to S15.

The analysis of textual content in step S12 may employ any suitable algorithm to analyze the extracted text of the received fax. For example, known algorithms used in email spam filters may be employed for this step. This analysis step may also employ a content analysis approach. Content analysis generally refers to the technology for structuring and analyzing textual information, where the complicated textual information or many words of a text are summarized and classified into much fewer content categories. Natural language processing is generally used to conduct automatic content analysis. Content analysis and natural language processing may be applied to analyze the extracted text in a fax in step S12.

A preferred embodiment for carrying out step S12 is described below. This analysis step searches for and evaluates a number of textual content types from the extracted text of the fax document, and calculates a relevance measure based thereon. These textual content types, which are commonly found in advertisement materials, may include one or more of:

(1) F1: Description of goods or services provided. Natural language analysis may be applied to identify this type of content.

(2) F2: Contact information, such as phone number, address, email, website, Facebook address, etc.

(3) F3: Price information, such as “price”, “$”, “dollars”, etc.

(4) F4: Sale information, such as “ . . . % off”, “special offer”, “reduced”, etc.

(5) F5: Valid period of goods or services offered, such as “limited time offer”, “offer expires . . . ”, “sale ends . . . ”, etc.

(6) F6: Goods or services quality information, such as “guaranteed”, “risk-free”, “money-back”, etc.

Each of the above values F1 to F6 is assigned based on the frequency of occurrence of the content type, such as the number of times the above listed keywords appear in the text. A first relevance value R1 is defined based on the values F1 to F6 as follows:

R1=W1*F1+W2*F2 . . . +W6*F6, where Wi are weighting factors.

It can be seen that, unlike many email spam filter algorithms, the preferred embodiment for step S12 described here does not use pure keyword matching. Rather, this step employs a type of content based analysis to analyze the overall content of the extracted text. For example, the keywords described above (F3 to F6) are words that are often found in legitimate faxes, but the above algorithm identifies and evaluates them as a part of the overall content analysis. Alternatively, this content based analysis may be used in combination with known keyword based filtering algorithms such as those used in many email spam filters.

The image pattern based analysis in step S13 examines the entire image of the fax document to extract certain image pattern properties, and calculates a relevance measure based thereon. These image pattern properties, which tend to distinguish advertisement materials from other types of documents, may include one or more of:

(1) F7: Average character size. Advertisement materials tend to use larger character sizes.

(2) F8: Standard deviation of character size. Advertisement materials tend to use a wider range of different character sizes, including larger characters for information such as price to catch viewers' eyes, and smaller characters for “boiler plate” type of language.

(3) F9: Ratio of character size at 99 percentile vs. 1 percentile. For the same reason mentioned above for F8, this ratio tends to be larger for advertisement materials. Other percentile values may be used, such as 98 percentile vs. 2 percentile, etc.

(4) F10: Difference between average density of text areas and a predefined density value. Here, density may be defined as the number of words or characters per square inch, or pixel density. The difference is a positive value and may be defined in any suitable ways. Advertisement materials tend to have high density or low density.

(5) F11: Standard deviation of density of text areas. Advertisement materials tend to have areas of high density and areas of low density coexisting in the same image.

A second relevance value R2 is defined based on the values F7 to F11 as follows:

R2=W7*F7+W8*F8 . . . +W11*F11, where Wi are weighting factors.

It should be noted that the image pattern based analysis in step S13 does not rely on the OCR step S11. For example, character size and character or word density may be determined by performing a connected component analysis of the bitmap image without actually recognizing the characters.

The statistical analysis in step S14 analyzes the received fax based on statistic features, including past user actions. The following statistical features may be examined:

(1) F12: The number of faxes from the same sender that has been previously determined to be unwanted by the fax machine.

(2) F13: The number of faxes from the same sender that has been previously determined to be unwanted as indicated by past user actions (such as deleting, moving to junk or confirmed folder, leaving in junk folder, not printing the fax, etc.).

(3) F14: The number of faxes from the same sender that has been previously determined to be legitimate by the fax machine.

(4) F15: The number of faxes from the same sender that has been previously determined to be legitimate as indicated by past user actions (such as printing, reprinting, forwarding, moving out of junk folder, not moving to junk folder, etc.).

The values F12 to F15 are obtained from the statistical information maintained by the fax machine as described earlier.

A third relevance value R3 is defined based on the values F12 to F15 as follows:

R3=W12*F12+W13*F13 . . . +W15*F15, where Wi are weighting factors.

Note that the weighting factors for F14 and F15 should be negative; i.e., higher numbers of previously determined legitimate faxes will lower the relevance value R3. Other alternative definition of R3 may be used, as long as it is defined such that higher F12 and F13 values will result in a higher relevance value and higher R14 and R15 values will result in a lower relevance value. For example,

R3=W12*F12/F14+W13*F13/F15, or

R3=(W12*F12+W13*F13)/(W14*F14+W15*F15), or

R3=W12*F12+W13*F13+W14/F14+W15/F15, etc.

In one embodiment, the statistical analysis step S14 takes into consideration of the situation where multiple users share a fax machine. Unlike email accounts, a fax machine is often shared by multiple different users within an organization (e.g., different individuals, different departments, etc.). Sometimes, some users may consider a fax to be unwanted, but other users may not consider it to be unwanted. The fax machine maintains user accounts so that the actions of different user accounts may be tracked. The statistical information recorded in step S19 reflects user actions associated with different user accounts, and the statistical analysis is performed accordingly. For example, if all users or a majority of users consider a fax to be unwanted, the value F11 will be higher than when only a minority of users considered it unwanted. An action done by administrator may be considered as determinative. Also, a fax sender should not be added to the blocked sender list unless all users conforms such an action. In one embodiment, useful for a fax machine shared by users in a large organization, user actions can be collected and classified according to the department or group that the users belong to and the recorded user actions can be used to process received faxes for different departments or groups accordingly.

Then, an overall relevance value R is calculated as follows (step S15):

R=WR1*R1+WR2*R2+WR3*R3, where WRi are weighting factors.

Or, the overall relevance value R may be defined based on the values F1 to F15 (referred to as factor values) as follows:

R=WF1*F1+WF2*F2 . . . +WF15*F15, where WFi are weighting factors.

As mentioned earlier, the weighting factors for F14 and F15 should be negative.

Alternatively, the overall relevance value may be defined in other suitable ways, so long as it's value is higher for higher values of F1 to F13 and lower values of F14 and F15.

When the overall relevance value R is greater than a threshold RT, the received fax is determined to be unwanted fax (“Y” in step S16); otherwise it is determined to be legitimate (“N” in step S16). As mentioned earlier, the fax machine will take appropriate actions based on the determination (steps S17 and S18).

Alternatively, in step S15 and S16, the three relevance values R1, R2 and R3 are separately compared to three threshold values RT1, RT2 and RT3, and the fax is determined to be unwanted if any relevance value is greater than the corresponding threshold value. Alternatively, the fax may be determined to be unwanted if any two relevance values are greater than the corresponding threshold values, or only when all three relevance values are greater than the corresponding threshold values.

The weighting factors W1 to W15 and/or WR1 to WR3, as well as the threshold value RT and/or RTj (j=1, 2, 3), may be determined empirically. Preferably, they are adjusted automatically by the fax machine based on user feedback such as the various user actions described earlier. For example, user actions of printing, reprinting or forwarding a fax or moving it out of the junk folder tend to indicate that the fax is legitimate, and user actions of deleting a fax without printing or moving it to a junk folder tend to indicate that the fax is unwanted. In one embodiment, the fax machine stores the factor values F1 to F15 for each fax analyzed, along with the user actions which indicate the user's confirmation or reversal of the determination made by the fax machine. Based on such stored data for a collection of previously processed faxes, the fax machine calculates optimum values for the weighting factors and threshold values that maximize the correct positive detection rate (i.e. the percentage of unwanted faxes that is correctly identified by the fax machine) and minimizes false positive detection rate (i.e. the percentage of legitimate faxes that is incorrectly identified as unwanted by the fax machine) for the collection of faxes. In this manner, the analysis algorithm has a self learning ability and the accuracy of the determination result can be improved over time. In another embodiment, the fax machine dynamically calculates the weighting factors when processing each received fax, e.g., based on the relation between the current factor value Fi and the distribution of recorded Fi for past faxes. This also gives the analysis algorithm a self-learning ability. More generally, any suitable learning approaches may be used, such as those conventionally used in machine learning, including supervised learning, unsupervised learning, semi-supervised learning, reinforcement learning, etc.

From the above descriptions, it can be seen that the analysis and processing method according to embodiments of the present invention takes advantage of the image nature of fax documents (step S13) to help determine whether a fax is likely unwanted. Further, a content based analysis is used to analyze the extracted textual content (step S12), improving the ability to detect advertisement materials. Moreover, the statistical analysis in step S14 takes into consideration the fact that a fax machine may be shared by multiple users, and treats the statistical information accordingly. These aspects make the fax document analysis and processing method uniquely useful as a spam filter for faxes.

It will be apparent to those skilled in the art that various modification and variations can be made in the fax document analysis and processing method and related apparatus of the present invention without departing from the spirit or scope of the invention. Thus, it is intended that the present invention cover modifications and variations that come within the scope of the appended claims and their equivalents.

What is claimed is:

1. A method implemented in a fax machine for analyzing and processing a received fax document, the fax document being in the form of an image, comprising:
(a) performing optical character recognition on the image to extract textual content of the received fax document;
(b) analyzing the textural content to obtain a first plurality of factor values;
(c) analyzing patterns of the image to obtain a second plurality of factor values;
(d) performing statistical analysis based on stored statistical data and a detected identification of a sender of the fax document to obtain a third plurality of factor values;
(e) determining whether the received fax document is unwanted or legitimate based on the first, second and third plurality of factor values; and
(f) when the received fax document is determined to be legitimate, printing the fax document, and when the received fax document is determined to be unwanted, either printing the fax document using a lower image quality or saving the fax document in the fax machine without printing it.

2. The method of claim 1, wherein step (b) comprises:
obtaining, as the first plurality of factor values, frequencies of occurrences of one or more or more of: a description of goods or service provided, contact information, price information, sale information, valid period of goods or services offered, and goods or services quality information.

3. The method of claim 1, wherein step (c) comprises:
obtaining, as the second plurality of factor values, one or more or more of: an average character size of the fax document, a standard deviation of character size of the fax document, a ratio of character size at a first percentile value over character size at a second percentile value of the fax document, a difference between average of density of text areas of the fax document and a predefined density value, and a standard deviation of density of text areas of the fax document.

4. The method of claim 3, wherein the density of text area is defined as a number of words per square inch, or a number of characters per square inch, or pixel density.

5. The method of claim 1, wherein step (d) comprises:
obtaining from stored statistical data, as the third plurality of factor values, a number of fax documents from the sender that has been previously determined to be unwanted by the fax machine, a number of fax documents from the sender that has been previously determined to be unwanted by a user, a numbers of fax documents from the sender that has been previously determined to be legitimate by the fax machine, and a numbers of fax documents from the sender that has been previously determined to be legitimate by the user.

6. The method of claim 1, further comprising, after steps (a) through (d) and before step (e),
(g) calculating an overall relevance value using the first, second and third plurality of factor values and a plurality weighting factors, each weighting factor being associated with one factor value of the first, second and third plurality of factor values; and
wherein step (e) comprises determining whether the received fax document is unwanted or legitimate by comparing the overall relevance value with a threshold value.

7. The method of claim 1, wherein step (a) further comprises calculating a first relevance value using the first plurality of factor values and a first plurality weighting factors, each of the first plurality of weighting factors being associated with one of the first plurality of factor values;
wherein step (b) further comprises calculating a second relevance value using the second plurality of factor values and a second plurality weighting factors, each of the second plurality of weighting factor being associated with one of the second plurality of factor values;
wherein step (c) further comprises calculating a third relevance value using the third plurality of factor values and a third plurality weighting factors, each of the third plurality of weighting factor being associated with one of the third plurality of factor values; and
wherein step (e) comprises determining whether the received fax document is unwanted or legitimate by comparing the first, second and third relevance values with respective first, second and third threshold values.

8. The method of claim 1, wherein step (f) further includes, when the received fax document is determined to be unwanted, displaying an alert on the fax machine.

9. The method of claim 1, wherein step (f) further includes, when the received fax document is determined to be unwanted, moving the fax document into a junk folder.

10. The method of claim 9, further comprising:
(h) after step (f), receiving one or more user inputs representing user actions, wherein the user actions include one or more of: printing the fax document, reprinting the fax document, forwarding the fax document, deleting the fax document, moving the fax document to the junk folder, and moving the fax document out of the junk folder;
(i) based on the user actions in step (h), making a confirmed determination of whether the received fax document is unwanted or legitimate; and
(j) storing the user actions received in step (h) and/or the confirmed determination in step (i) in association with the identification of the sender of the fax document as a part of the statistical data.

11. The method of claim 10, further comprising
(k) maintaining a plurality of user accounts;
(l) wherein each user input in step (h) is associated with a user account.

12. A fax machine comprising:
a scanning section for scanning hard copy documents to be sent as fax;
a printing section for printing received fax documents;
a communication interface section for transmitting and receiving fax documents;
a user interface section for receiving user input;
a memory for storing a computer readable program code and data; and
a processing section for executing the computer readable program code stored in the memory to control the fax machine to perform a process which comprises:
(a) performing optical character recognition on the image to extract textual content of the received fax document;
(b) analyzing the textural content to obtain a first plurality of factor values;
(c) analyzing patterns of the image to obtain a second plurality of factor values;
(d) performing statistical analysis based on stored statistical data and a detected identification of a sender of the fax document to obtain a third plurality of factor values;
(e) determining whether the received fax document is unwanted or legitimate based on the first, second and third plurality of factor values; and
(f) when the received fax document is determined to be legitimate, printing the fax document, and when the received fax document is determined to be unwanted, either printing the fax document using a lower image quality or saving the fax document in the fax machine without printing it.

13. The fax machine of claim 12, wherein in the process, step (b) comprises obtaining, as the first plurality of factor values, frequencies of occurrences of one or more or more of: a description of goods or service provided, contact information, price information, sale information, valid period of goods or services offered, and goods or services quality information.

14. The fax machine of claim 12, wherein in the process, step (c) comprises obtaining, as the second plurality of factor values, one or more or more of: an average character size of the fax document, a standard deviation of character size of the fax document, a ratio of character size at a first percentile value over character size at a second percentile value of the fax document, a difference between average of density of text areas of the fax document and a predefined density value, and a standard deviation of density of text areas of the fax document.

15. The fax machine of claim 12, wherein in the process, step (d) comprises obtaining from stored statistical data, as the third plurality of factor values, a number of fax documents from the sender that has been previously determined to be unwanted by the fax machine, a number of fax documents from the sender that has been previously determined to be unwanted by a user, a numbers of fax documents from the sender that has been previously determined to be legitimate by the fax machine, and a numbers of fax documents from the sender that has been previously determined to be legitimate by the user.

16. The fax machine of claim 12, wherein the process further comprises, after steps (a) through (d) and before step (e),
(g) calculating an overall relevance value using the first, second and third plurality of factor values and a plurality weighting factors, each weighting factor being associated with one factor value of the first, second and third plurality of factor values; and
wherein step (e) comprises determining whether the received fax document is unwanted or legitimate by comparing the overall relevance value with a threshold value.

17. The fax machine of claim 12, wherein in the process, step (a) further comprises calculating a first relevance value using the first plurality of factor values and a first plurality weighting factors, each of the first plurality of weighting factors being associated with one of the first plurality of factor values;
step (b) further comprises calculating a second relevance value using the second plurality of factor values and a second plurality weighting factors, each of the second plurality of weighting factor being associated with one of the second plurality of factor values;
step (c) further comprises calculating a third relevance value using the third plurality of factor values and a third plurality weighting factors, each of the third plurality of weighting factor being associated with one of the third plurality of factor values; and
step (e) comprises determining whether the received fax document is unwanted or legitimate by comparing the first, second and third relevance values with respective first, second and third threshold values.

18. The fax machine of claim 12, wherein in the process, step (f) further includes, when the received fax document is determined to be unwanted, displaying an alert on the fax machine.

19. The fax machine of claim 12, wherein in the process, step (f) further includes, when the received fax document is determined to be unwanted, moving the fax document into a junk folder.

20. The fax machine of claim 19, wherein the process further comprises:
(h) after step (f), receiving one or more user inputs representing user actions, wherein the user actions include one or more of: printing the fax document, reprinting the fax document, forwarding the fax document, deleting the fax document, moving the fax document to the junk folder, and moving the fax document out of the junk folder;
(i) based on the user actions in step (h), making a confirmed determination of whether the received fax document is unwanted or legitimate; and
(j) storing the user actions received in step (h) and/or the confirmed determination in step (i) in association with the identification of the sender of the fax document as a part of the statistical data.
